(19) United States
(12) Patent Application Publication
(10) Pub. No.: US 2026/0030601 A1
(43) Pub. Date: Jan. 29, 2026

(54) GRANTING METHOD, INFORMATION PROCESSING DEVICE, AND PROGRAM FOR GRANTING POINTS

(71) Applicant: Panasonic Intellectual Property Management Co., Ltd., Osaka (JP)

(72) Inventors: Kenta MURAKAMI, Chiba (JP); Hiroko IZUMI, Kanagawa (JP); Harumi OTSUKA, Hyogo (JP); Hiromitsu MORISHITA, Kanagawa (JP); Takuya YAMAGUCHI, Osaka (JP); Masashi OTANI, Osaka (JP)

(73) Assignee: Panasonic Intellectual Property Management Co., Ltd., Osaka (JP)

(21) Appl. No.: 19/342,623

(22) Filed: Sep. 28, 2025

Related U.S. Application Data
(63) Continuation of application No. PCT/JP2024/009511, filed on Mar. 12, 2024.

(30) Foreign Application Priority Data
Mar. 29, 2023 (JP) 2023-054293

(51) Int. Cl. G06Q 50/00

(52) U.S. Cl. CPC G06Q 50/01

(57) ABSTRACT

A technology for evaluating actions that contribute to recipes is to be provided. A recipe management device includes a communication unit, a processing unit, and a storage unit. The communication unit of the recipe management device receives, via a network, information indicating contribution to a recipe for a dish. The processing unit of the recipe management device grants, after the communication unit receives information indicating contribution to a recipe for a dish, a point for the recipe for the dish.

This application is based upon and claims the benefit of priority from the prior Japanese Patent Application No. 2023-054293, filed on Mar. 29, 2023, the entire contents of which are incorporated herein by reference.

### BACKGROUND

### 1. Technical Field

The present disclosure relates to an information processing technology, and particularly to a granting method, an information processing device, and a program for granting points.

### 2. Description of the Related Art

In a service that provides recipes, when recipes created by various users are posted, these recipes are published and distributed on the Internet. In addition, this service also accepts and publishes reports from users who actually cooked based on the recipes (see Patent Literature 1, for example).

### PRIOR ART REFERENCE

### Patent Literature

Patent Literature 1: Japanese Unexamined Patent Application Publication No. 2020-57095

In such a service, users who can cook and serve with high motivation make posts, and users who have cooked these recipes evaluate or review the recipes. In other words, only a user who has created a new recipe is evaluated. Meanwhile, in a situation where cooking is performed on a daily basis, a user who actually cooked a recipe also contributes to the recipe. Further, ingenuity and ideas, such as modifications of recipes, created while cooking from recipes on a daily basis also contribute to the recipes. However, these actions are not posted and therefore not evaluated.

### SUMMARY

The present disclosure has been made in view of such a situation, and a general purpose thereof is to provide a technology for evaluating actions that contribute to recipes.

In response to the above issue, a granting method according to one embodiment of the present disclosure includes: receiving, via a network, information indicating contribution to a recipe for a dish; and granting a point for the recipe after receiving the information indicating contribution.

Another embodiment of the present disclosure is an information processing device. This device includes: a communication unit that receives, via a network, information indicating contribution to a recipe for a dish; and a processing unit that grants a point for the recipe after the communication unit receives the information indicating contribution.

Optional combinations of the aforementioned constituting elements, and implementation of the present disclosure in the form of methods, apparatuses, systems, recording media, and computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIGS. 1A-1G illustrate configurations of an appliance control system according to an embodiment;

FIGS. 2A-2E illustrate configurations of functional blocks used in the appliance control system shown in FIGS. 1A-1G;

FIGS. 3A-3H illustrate configurations of functional block sequences used in the appliance control system shown in FIGS. 1A-1G;

FIG. 4 shows an overview of the operation of an appliance shown in FIGS. 1A-1G;

FIG. 5 illustrates a configuration of an information processing system in FIGS. 1A-1G;

FIG. 6 illustrates a configuration of an appliance shown in FIG. 5;

FIG. 7 illustrates a configuration of a user device shown in FIG. 5;

FIG. 8 is a sequential diagram that shows the procedure of a first processing example performed by the information processing system shown in FIG. 5;

FIG. 9 shows a screen displayed on a display unit shown in FIG. 7;

FIG. 10 shows a data structure of a database stored in a storage unit shown in FIG. 5;

FIG. 11 is a sequential diagram that shows the subsequent procedure of the first processing example performed by the information processing system shown in FIG. 5;

FIG. 12 is a sequential diagram that shows the procedure of a second processing example performed by the information processing system shown in FIG. 5;

FIG. 13 is a sequential diagram that shows the subsequent procedure of the second processing example performed by the information processing system shown in FIG. 5;

FIG. 14 is a sequential diagram that shows the procedure of a third processing example performed by the information processing system shown in FIG. 5;

FIG. 15 is a sequential diagram that shows the subsequent procedure of the third processing example performed by the information processing system shown in FIG. 5;

FIG. 16 is a sequential diagram that shows the procedure of a fourth processing example performed by the information processing system shown in FIG. 5; and

FIG. 17 shows a screen displayed on a display unit in a fifth processing example performed by the information processing system shown in FIG. 5.

### DETAILED DESCRIPTION

The invention will now be described by reference to the preferred embodiments. This does not intend to limit the scope of the present invention, but to exemplify the invention.

The embodiment described below shows a suitable specific example of the present disclosure. Therefore, the numerical values, shapes, materials, constituting elements, arranged positions and connection forms of the constituting elements, and the steps (processes) and the order of the steps, for example, described in the following embodiment are mere examples and are not intended to limit the present disclosure. Accordingly, among the constituting elements in the following embodiment, a constituting element that is not described in an independent claim, which indicates the most generic concept of the present disclosure, will be described as an arbitrary constituting element. Also, in each drawing, the same reference characters denote substantially the same configurations, and repetitive description will be omitted or simplified. In the following, the embodiment will be described in the following order: (1) Overview of functional blocks and functional block sequences, (2) Configuration of information processing system, (3) First processing example, (4) Second processing example, (5) Third processing example, (6) Fourth processing example, and (7) Fifth processing example.

### (1) Overview of Functional Blocks and Functional Block Sequences

In household electrical machinery and equipment such as rice cookers, washing machines, and microwave ovens (hereinafter referred to as “appliances”), the functions and operations of hardware are controlled by software for achieving specific functions. In the present embodiment, an appliance control system is introduced as a mechanism to enable creation or updating of software for controlling an appliance.

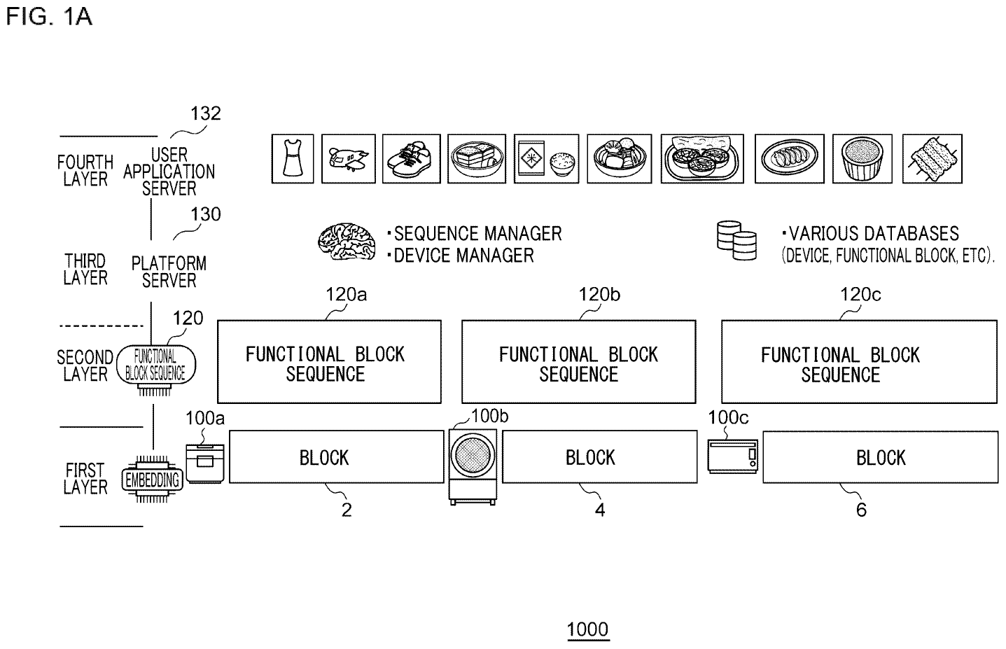

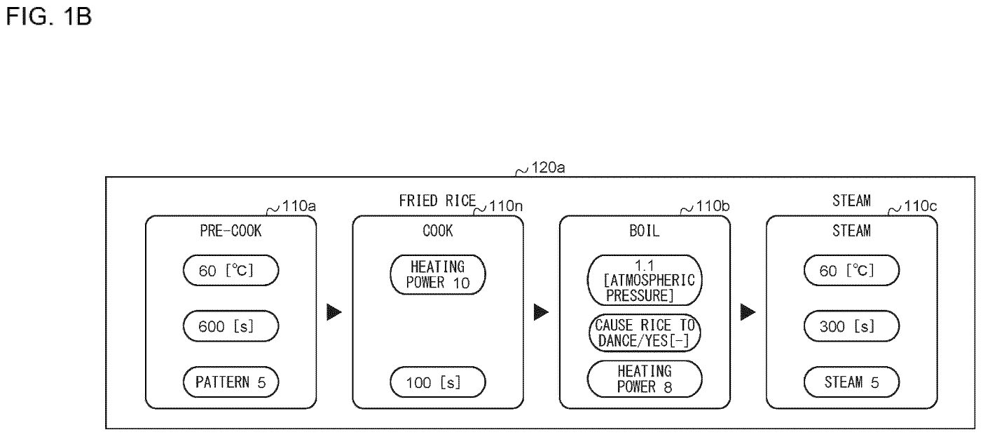

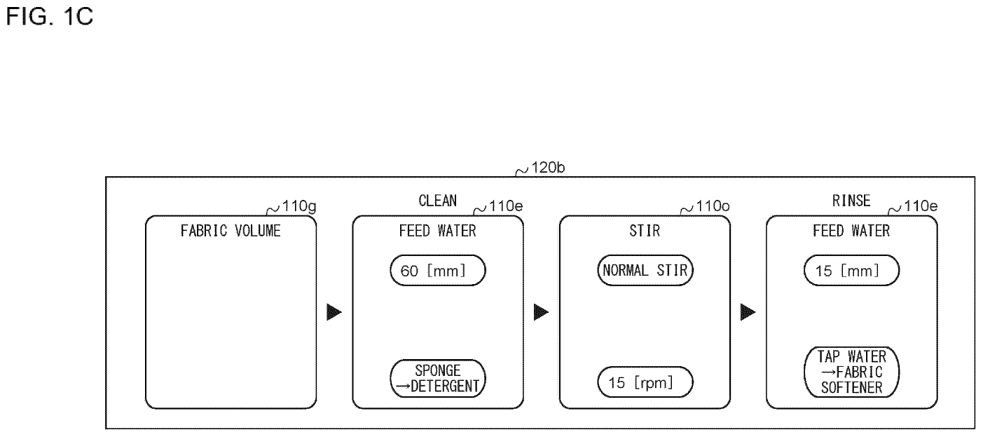

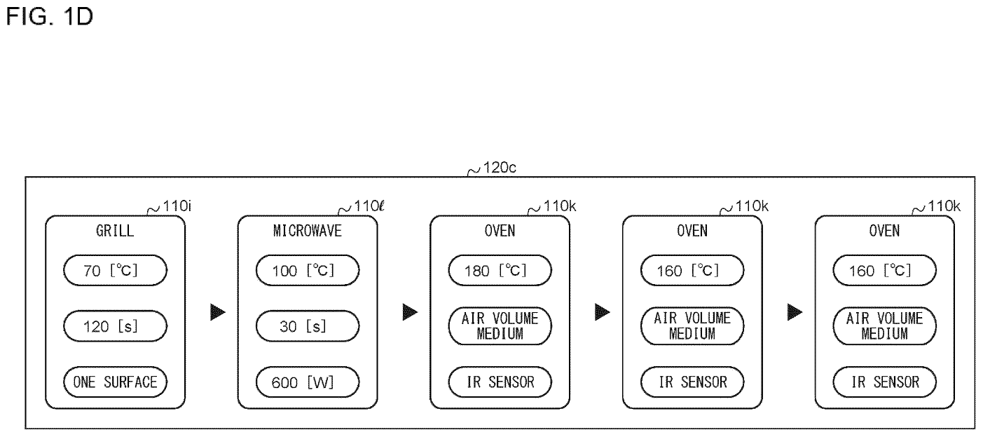

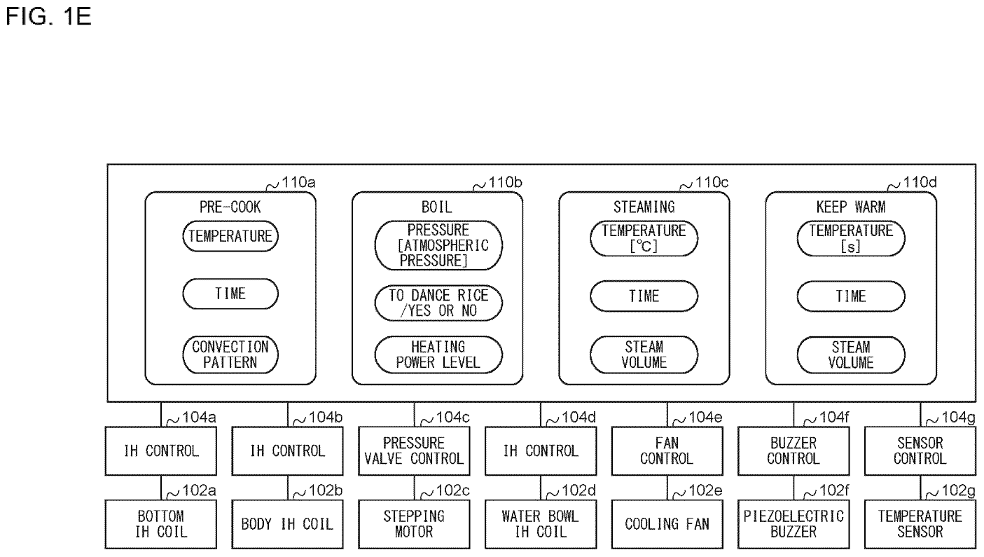

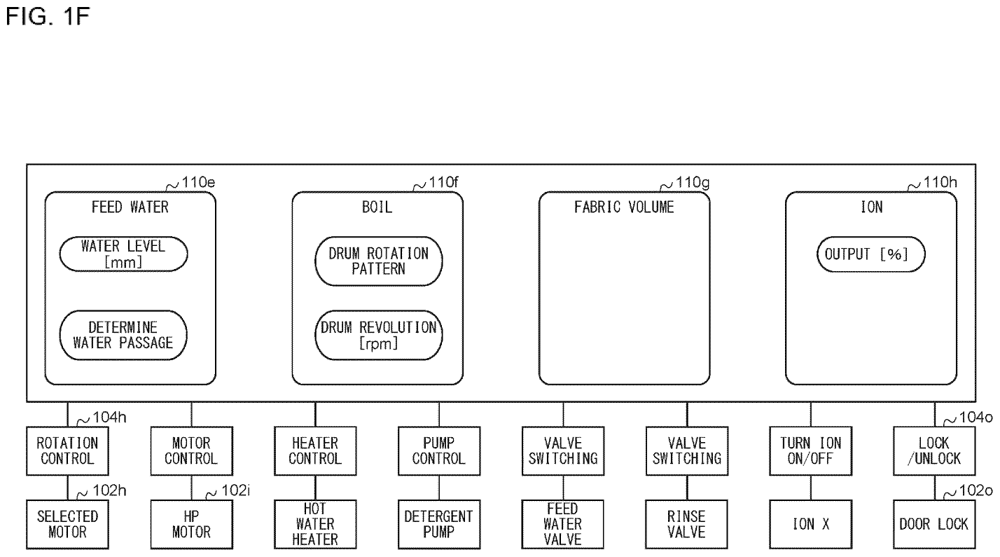

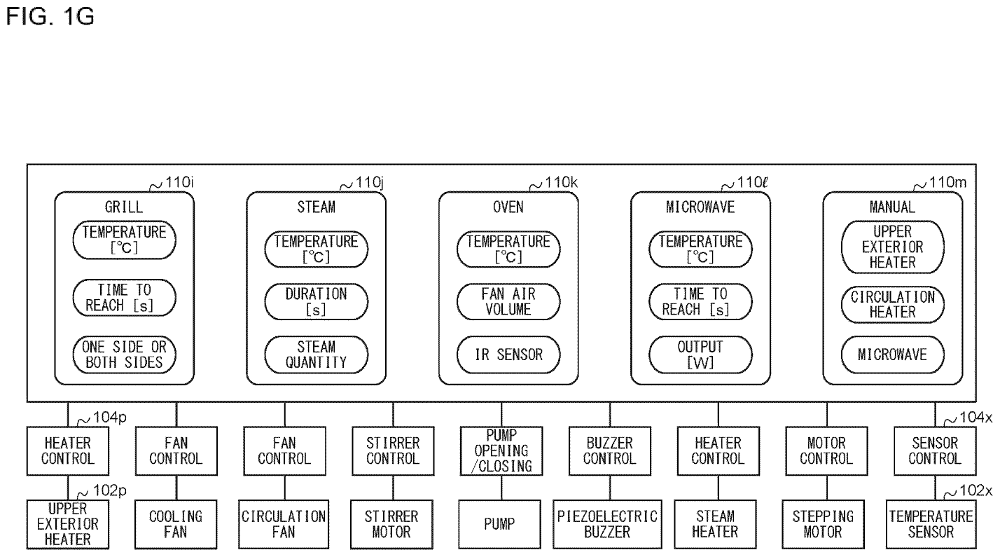

FIGS. 1A-1G illustrate configurations of an appliance control system 1000. In the appliance control system 1000, a four-layer model constituted by the first through fourth layers is defined. In the first layer, the configuration of each appliance 100 is defined. The appliances 100 may be, for example, a rice cooker (an appliance 100a), a washing machine (an appliance 100b), and a microwave oven (an appliance 100c). However, the appliances 100 are not limited thereto. Each appliance 100 includes a block 2 (FIG. 1E), a block 4 (FIG. 1F), or a block 6 (FIG. 1G), and multiple components 102, multiple drivers 104, and multiple functional blocks 110.

The components 102 are hardware elements constituting divided units of operations (actuation and sensing) of an appliance 100 and include actuators and sensors that perform functions of the appliance 100. Actuators are output devices, and sensors are input devices. The actuators include, for example, a bottom induction heating (IH) coil (component 102a), a body IH coil (component 102b), a stepping motor (component 102c), a water bowl IH coil (component 102d), a cooling fan (component 102e), and a piezoelectric buzzer (component 102f) in the rice cooker (appliance 100a). The sensors include, for example, a temperature sensor (component 102g) in the rice cooker (appliance 100a). The components 102 included in the rice cooker (appliance 100a) are not limited thereto, and the washing machine (appliance 100b) and the microwave oven (appliance 100c) are similarly configured.

A driver 104 is software for directly controlling a component 102. In the rice cooker (appliance 100a), IH control (a driver 104) controls the bottom IH coil (component 102a). Also, IH control (a driver 104b) controls the body IH coil (component 102b), pressure valve control (a driver 104c) controls the stepping motor (component 102c), and IH control (a driver 104d) controls the water bowl IH coil (component 102d). Further, fan control (a driver 104e) controls the cooling fan (component 102e), buzzer control (a driver 104f) controls the piezoelectric buzzer (component 102f), and sensor control (a driver 104g) controls the temperature sensor (component 102g). The drivers 104 included in the rice cooker (appliance 100a) are not limited thereto, and the washing machine (appliance 100b) and the microwave oven (appliance 100c) are similarly configured.

A functional block 110 is a software interface (API: Application Programming Interface) associated with one or more drivers 104 to cause one or more components 102 to operate. Each functional block 110 can receive one or more parameters for controlling the operation of a (each) component 102. The functional blocks 110 will be detailed later.

In the second layer, a functional block sequence 120 is defined, in which one or more functional blocks 110 are arranged in order of operation to cause an appliance 100 to perform intended processing. In other words, each functional block sequence 120 defines the order of execution of one or more functional blocks 110. The intended processing is defined for each appliance 100, such as cooking for the rice cooker (appliance 100a) and the microwave oven (appliance 100c), and laundry for the washing machine (appliance 100b). A functional block sequence 120a (FIG. 1B) is used for the rice cooker (appliance 100a), a functional block sequence 120b (FIG. 1C) is used for the washing machine (appliance 100b), and a functional block sequence 120c (FIG. 1D) is used for the microwave oven (appliance 100c). Each appliance 100 executes operations in the order of functional blocks 110 arranged in a functional block sequence 120. Therefore, the functions and operations of an appliance 100 can be updated by changing the arrangement of functional blocks 110 or changing a parameter set in a functional block 110. The functional block sequences 120 will be detailed later.

In the third layer, a platform server 130, which manages various pieces of information in the appliance control system 1000, is located. The platform server 130 includes a sequence manager, a device manager, and various databases. The sequence manager manages the functional block sequences 120, the device manager manages registration information of each appliance 100 in which a functional block sequence 120 can be used, and the various databases manage user information of each user who can use a functional block sequence 120.

In the fourth layer, a user application server 132, which publishes each functional block sequence 120 as a user application, is located. Each functional block sequence 120 published on the user application server 132 is downloaded to an appliance 100. The downloaded functional block sequence 120 is made usable in the appliance 100. When another functional block sequence 120 is downloaded to the appliance 100, the another functional block sequence 120 is made usable in the appliance 100.

The third and fourth layers in the appliance control system 1000 may be integrated. In that case, the platform server 130 and the user application server 132 are integrally configured. Also, the third and fourth layers in the appliance control system 1000 may be arranged in the same layer. Further, the third and fourth layers in the appliance control system 1000 may be omitted. In that case, a functional block sequence 120 is downloaded from a user device (not illustrated) that a user possesses to an appliance 100.

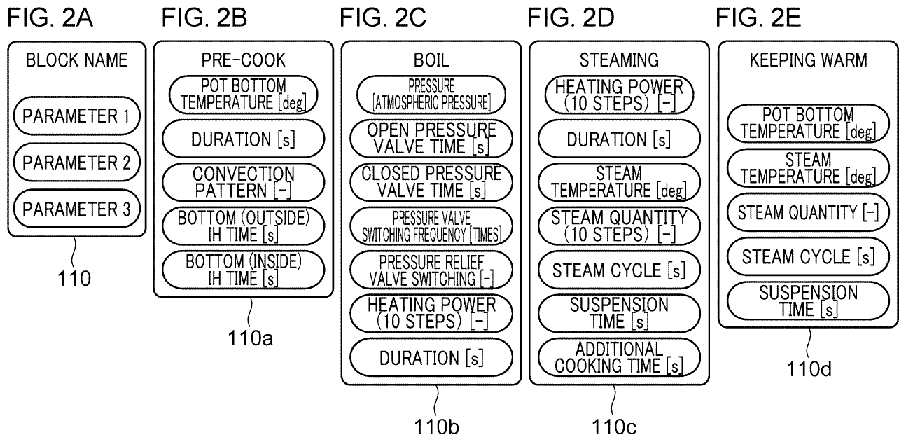

FIGS. 2A-2E illustrate configurations of functional blocks 110 used in the appliance control system 1000. FIG. 2A shows a basic configuration of a functional block 110. The functional blocks 110 are defined in units of functions that can be performed by the appliances 100 and each have a “block name” corresponding to the function. In each functional block 110, multiple parameters associated with the function can be set. Each parameter set in a functional block 110 is output to a driver 104. When receiving a parameter from a functional block 110, the driver 104 controls the operation of a component 102 based on the parameter.

FIG. 2B shows a “pre-cook” functional block 110a in the rice cooker (appliance 100a) shown in FIG. 1A. In the “pre-cook” functional block 110a, the pot bottom temperature, duration, convection pattern, bottom (outside) IH time, and bottom (inside) IH time can be set as parameters. Also, FIG. 2C shows a “boil” functional block 110b in the rice cooker (appliance 100a) shown in FIG. 1A, FIG. 2D shows a “steaming” functional block 110c in the rice cooker (appliance 100a) shown in FIG. 1A, and FIG. 2E shows a “keeping warm” functional block 110d. Multiple parameters can be set also in each of the functional blocks 110b through 110d. The same applies to the functional blocks 110 in the washing machine (appliance 100b) and the microwave oven (appliance 100c) shown in FIG. 1A.

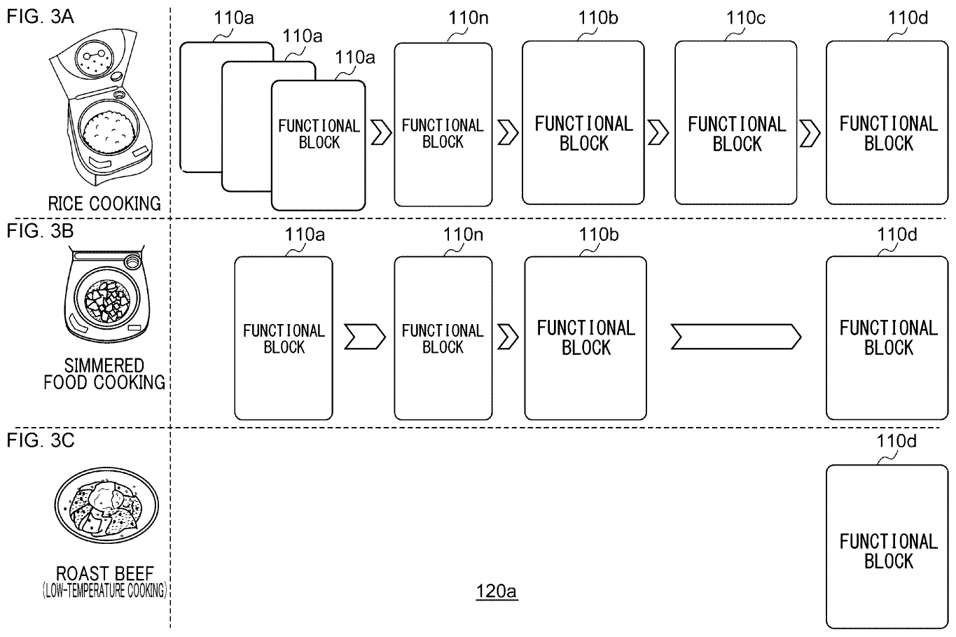

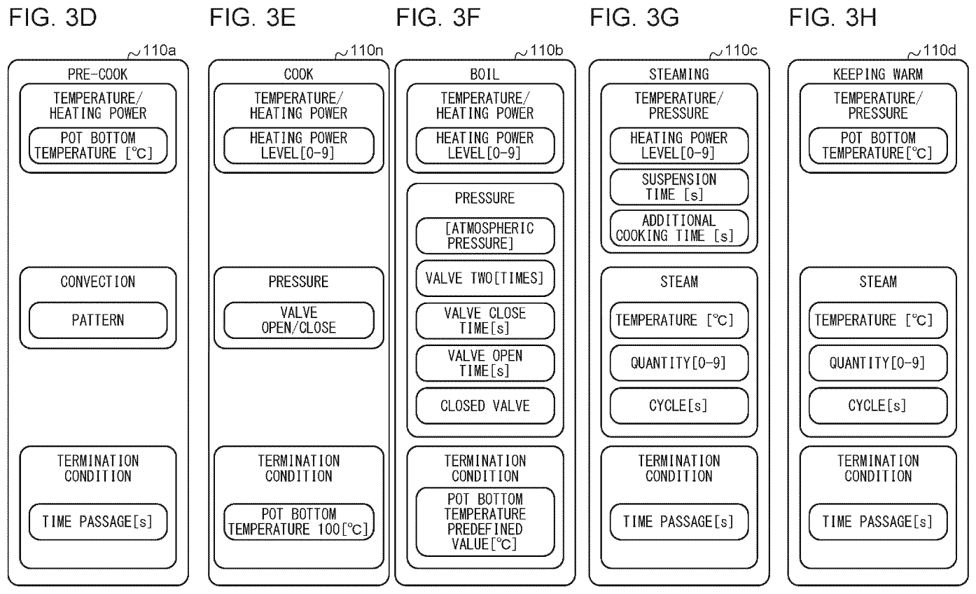

FIGS. 3A-3H illustrate configurations of functional block sequences 120 used in the appliance control system 1000, in particular functional block sequences 120a used in the rice cooker (appliance 100a) shown in FIG. 1A. FIG. 3A shows a sequence for “rice cooking”, FIG. 3B shows a sequence for “simmered food cooking”, and FIG. 3C shows a sequence for “roast beef (low-temperature cooking)”.

In the sequence for “rice cooking” shown in FIG. 3A, three “pre-cook” functional blocks 110a (FIG. 3D), a “cook” functional block 110n (FIG. 3E), a “boil” functional block 110b (FIG. 3F), a “steaming” functional block 110c (FIG. 3G), and a “keeping warm” functional block 110d (FIG. 3H) are arranged in this order. In the three “pre-cook” functional blocks 110a, parameters different from each other are set. Thus, by sequentially arranging the three “pre-cook” functional blocks 110a in which parameters different from each other are set, three-step pre-cooking can be performed.

In the sequence for “simmered food cooking” shown in FIG. 3B, a “pre-cook” functional block 110a, a “cook” functional block 110n, a “boil” functional block 110b, and a “keeping warm” functional block 110d are arranged in this order. In the sequence for “roast beef (low-temperature cooking)” shown in FIG. 3C, a “keeping warm” functional block 110d is included. Thus, by changing the types, arrangement, and parameters of the functional blocks 110 to be used, the processes with different purposes of “rice cooking”, “simmered food cooking”, and “roast beef (low-temperature cooking)” can be performed. The same applies to the functional block sequences 120 for the washing machine (appliance 100b) and the microwave oven (appliance 100c) shown in FIG. 1A.

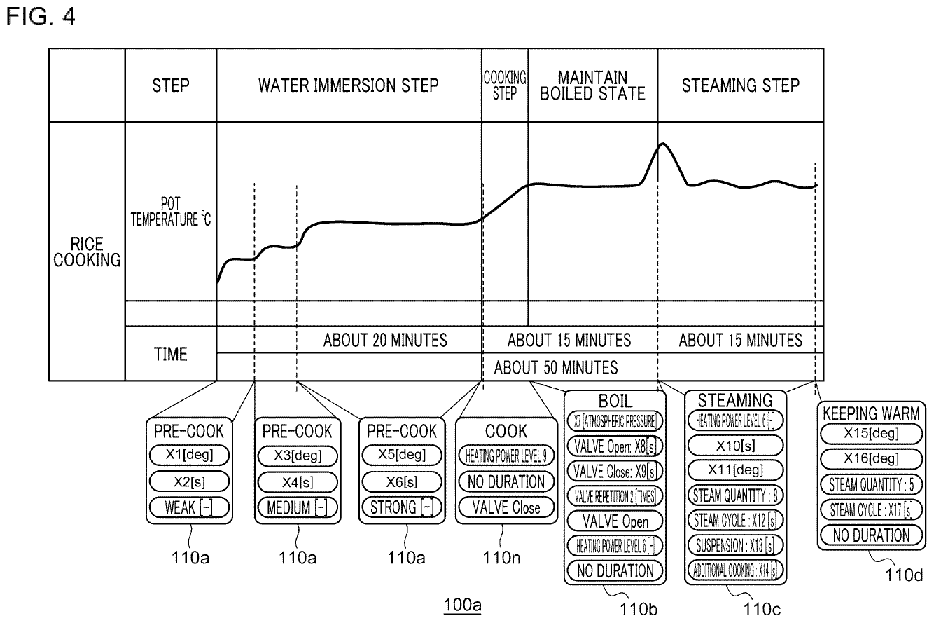

FIG. 4 shows an overview of the operation of an appliance 100, in particular the rice cooker (appliance 100a) shown in FIG. 1A. FIG. 4 shows the operation of the appliance 100a according to the sequence for “rice cooking” in FIG. 3A. In a water immersion step, the three “pre-cook” functional blocks 110a in which parameters different from each other are set are sequentially performed, so that the components 102 corresponding thereto operate based on the parameters. As a result, the pot temperature increases in a stepwise manner over time. Subsequently, the “cook” functional block 110n, the “boil” functional block 110b, the “steaming” functional block 110c, and the “keeping warm” functional block 110d are sequentially performed, so that the components 102 corresponding thereto operate based on the parameters. That is, the multiple functional blocks 110 are sequentially performed, and hence, the rice cooking is performed in the appliance 100a.

In the description given above, functional blocks 110 are defined in units of functions that can be performed by an appliance 100, and a functional block sequence 120 is defined in which one or more functional blocks 110 are arranged in order of operation. Such functional blocks 110 do not include operations to be performed by a person. Meanwhile, actual intended processing may require an operation to be performed by a person. To handle the situation, in the following, the functional blocks 110 and the functional block sequences 120 described above will be extended. Accordingly, the functional blocks 110 will also be defined in units of operations to be performed by a person. With such representation of the functional blocks 110, a person's operations can be treated in the same manner as operations of an appliance 100. Also, functional blocks 110 defined in units of functions that can be performed by an appliance 100 are defined as “first-type blocks”, and functional blocks 110 defined in units of operations to be performed by a person are defined as “second-type blocks”. In the following, the functional blocks 110 will be used without distinguishing between the first-type blocks and the second-type blocks.

### (2) Configuration of Information Processing System

A documented procedure that shows a procedure for cooking a dish is generally called a “recipe”. In a recipe, processes such as “baking” and “steaming” are sequentially arranged. Such a recipe is often provided as a document describing how to cook a dish. Meanwhile, in a functional block sequence 120 used to cook a dish, one or more functional blocks 110 are arranged in order of operation, as described previously. Thus, a functional block sequence 120 and functional blocks 110 have roles similar to a recipe and processes. In the following, a functional block sequence 120 is treated as one form of a recipe. That is, a recipe includes a document describing how to cook a dish, and a functional block sequence 120.

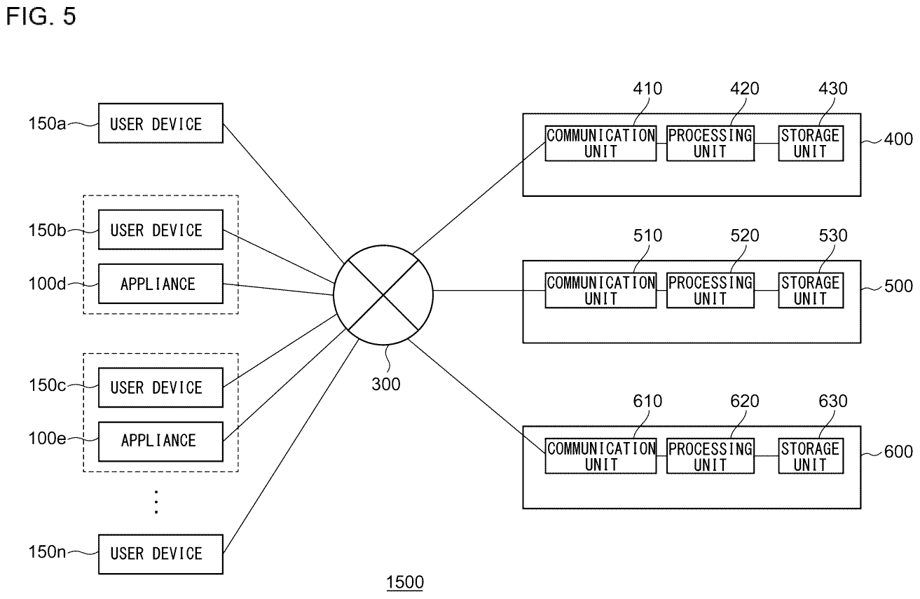

FIG. 5 shows a configuration of an information processing system 1500. The information processing system 1500 includes an appliance 100d, an appliance 100e, a user device 150a, a user device 150b, a user device 150c, . . . , a user device 150n, a network 300, a recipe management device 400, a registration server 500, and a token management server 600. The recipe management device 400 includes a communication unit 410, a processing unit 420, and a storage unit 430; the registration server 500 includes a communication unit 510, a processing unit 520, and a storage unit 530; and the token management server 600 includes a communication unit 610, a processing unit 620, and a storage unit 630. The number of appliances 100 (the appliance 100d and appliance 100e) included in the information processing system 1500 is not limited to “2”. Also, at least two of the recipe management device 400, the registration server 500, and the token management server 600 may be integrally configured.

The combination of the recipe management device 400 and the registration server 500 corresponds to the platform server 130 and the user application server 132 shown in FIG. 1A. Therefore, the appliance 100d, the appliance 100e, the recipe management device 400, and the registration server 500 in the information processing system 1500 correspond to the appliance control system 1000 of FIG. 1A.

The appliance 100d and appliance 100e are cooking appliances, such as a rice cooker, a microwave oven, and an IH cooking heater. Each appliance 100 performs processes of the first layer and the second layer in FIGS. 1A and 1s connected to the network 300. Besides the appliances 100, the user devices 150a through 150n (user devices 150), the recipe management device 400, the registration server 500, and the token management server 600 are also connected to the network 300. In the network 300, one of wired communication, wireless communication, or a combination of wired communication and wireless communication is performed between these devices.

Each user device 150 is a device used by a user who performs intended processing, such as cooking, and may be a computer, a smartphone, or a tablet terminal, for example. In FIG. 5, the user device 150b and the appliance 100d are used by the same user, and the user device 150c and the appliance 100e are used by the same user. Here, as an example, the user device 150a is used by a user A, the user device 150b is used by a user B, and the user device 150c is used by a user C.

The user A creates a recipe using the user device 150a. The user device 150a transmits the recipe to the recipe management device 400 via the network 300. The recipe management device 400 may be, for example, a computer such as a server or a cloud server equipped with a processor, memory, and the like. Upon receiving a recipe from a user device 150, the recipe management device 400 inquires of the registration server 500 via the network 300 whether the recipe can be registered. The registration server 500 may also be, for example, a computer such as a server or a cloud server equipped with a processor, memory, and the like. In response to the inquiry from the recipe management device 400, the registration server 500 judges whether the recipe can be registered (stored). When the recipe can be registered, the registration server 500 registers the recipe and transmits the judgment result to the recipe management device 400 via the network 300. When the judgment result from the registration server 500 indicates that the recipe can be registered, the recipe management device 400 starts managing (storing) the recipe.

The user device 150b receives, from the user B, information (a purchase request) regarding a recipe of a dish to be cooked with the appliance 100d. The user device 150b transmits the information regarding the recipe to the recipe management device 400 via the network 300. Upon receiving the information regarding the recipe from the user device 150b, the recipe management device 400 transmits the information to the registration server 500 via the network 300. Upon receiving the information from the recipe management device 400, the registration server 500 selects a functional block sequence 120 corresponding to the recipe included in the information and transmits information on the functional block sequence 120 to the appliance 100d via the network 300. Upon receiving the information on the functional block sequence 120 from the registration server 500, the appliance 100d performs operation according to the functional block sequence 120.

As described previously, the user A is evaluated by creating a recipe. Meanwhile, even though the user B contributes to the recipe by cooking the recipe, the user B is not evaluated. While people cook with reference to recipes on a daily basis, if a community is formed in which cooking itself is praised and appreciated, the motivation of the user B to cook will be improved. The improvement in the motivation of the user B to cook will also lead to the activation of the use of recipes in the information processing system 1500. In the present embodiment, to improve the motivation of the user B who cooked a recipe, the token management server 600 issues a token and transmits the token to the user device 150b.

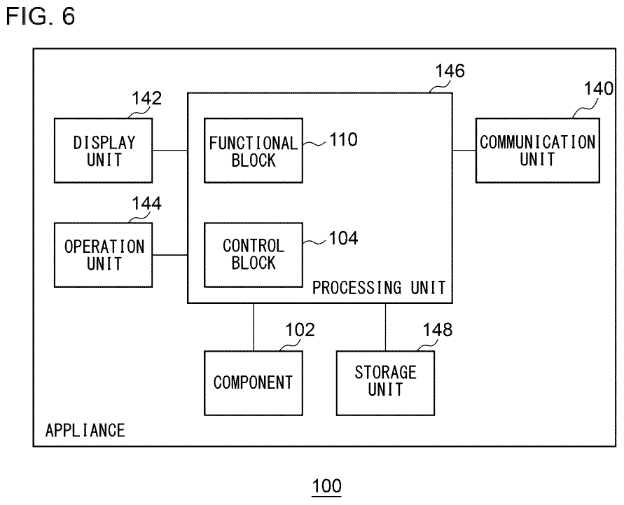

FIG. 6 shows a configuration of an appliance 100. The appliance 100 includes a component 102, a communication unit 140, a display unit 142, an operation unit 144, a processing unit 146, and a storage unit 148. The processing unit 146 includes a functional block 110 and a driver 104. As described previously, the appliance 100 is household electrical machinery and equipment for cooking, such as a rice cooker, a microwave oven, or an IH cooking heater. Although multiple components 102, multiple drivers 104, and multiple functional blocks 110 are provided as shown in FIGS. 1B-1G, only one of each is shown here for clarity of the drawing.

The communication unit 140 is connected to the network 300 and performs communication with the recipe management device 400 or the registration server 500 via the network 300. For example, the communication unit 140 receives information on a functional block sequence 120 from the registration server 500. This functional block sequence 120 includes a functional block 110 to be executed by the appliance 100, among the functional block sequences 120 for the intended processing. The storage unit 148 stores functional blocks 110 that can be executed by the appliance 100. The processing unit 146 reads a functional block 110 stored in the storage unit 148 based on the information on the functional block sequence 120 received at the communication unit 140 and allows a component 102, via a driver 104, to perform processing according to the functional block sequence 120. After performing the processing according to the functional block sequence 120, the processing unit 146 generates a notification indicating that the execution of the recipe has been completed (hereinafter referred to as the “recipe execution notification”), and the communication unit 140 transmits the recipe execution notification to the recipe management device 400.

The display unit 142 displays information from the processing unit 146. The operation unit 144 is an interface capable of receiving input from a user and may be a button, for example. The display unit 142 and the operation unit 144 may be integrated as a touch panel. The operation unit 144 then outputs the received input to the processing unit 146.

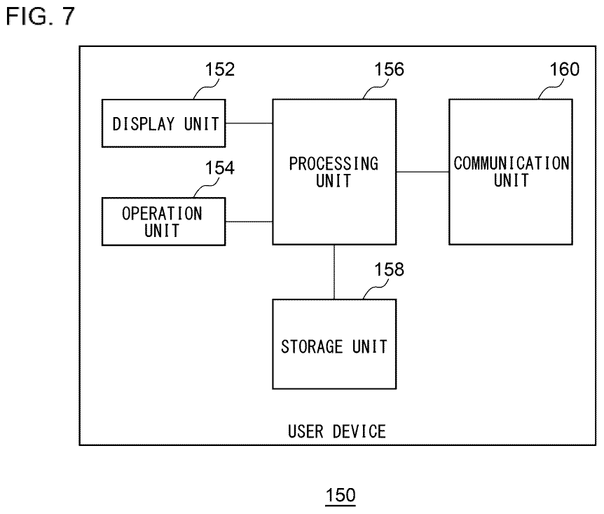

FIG. 7 shows a configuration of a user device 150. The user device 150 includes a display unit 152, an operation unit 154, a processing unit 156, a storage unit 158, and a communication unit 160. As described previously, the user device 150 may be a computer, a smartphone, or a tablet terminal. The display unit 152 displays information received from the processing unit 156. The operation unit 154 is an interface capable of receiving input from a user and may be a button, for example. The display unit 152 and the operation unit 154 may be integrated as a touch panel. The operation unit 154 then outputs the received input to the processing unit 156.

The processing unit 156 outputs information to be displayed to the display unit 152 and receives input from the operation unit 154. The processing unit 156 also stores information in the storage unit 158 and reads information from the storage unit 158. Further, the processing unit 156 connects to the network 300 via the communication unit 160 and performs communication with the recipe management device 400, the registration server 500, or the token management server 600 via the network 300. With such a configuration, when the operation unit 154 receives predetermined information from a user, the processing unit 156 allows the communication unit 160 to transmit the predetermined information to the recipe management device 400.

### (3) First Processing Example

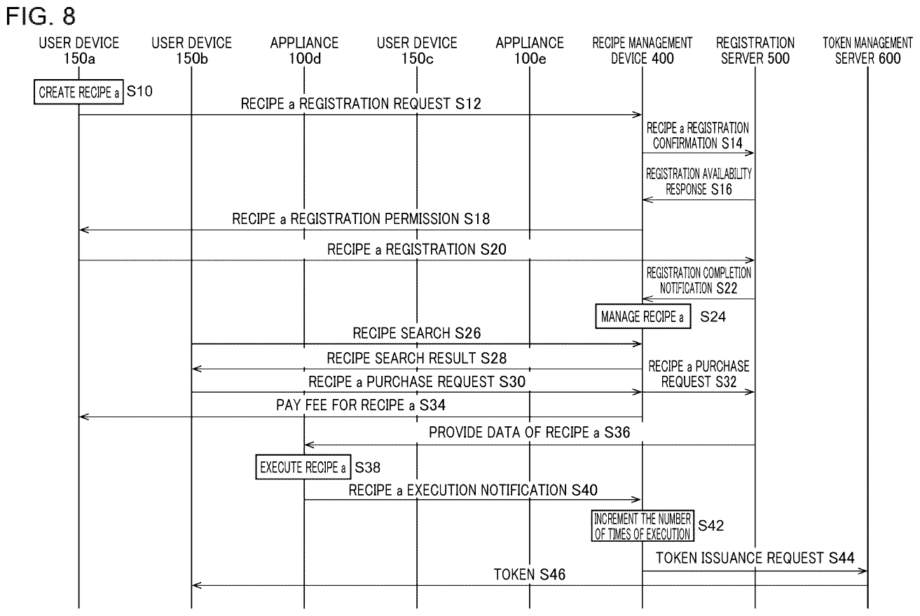

In the following, processing (a first processing example) performed by the information processing system 1500 will be described while using FIGS. 8 through 11. FIG. 8 is a sequential diagram that shows the procedure of the first processing example performed by the information processing system 1500. When the operation unit 154 of the user device 150a receives a corresponding operation by the user A, the processing unit 156 creates a recipe (hereinafter referred to as a “recipe a”) (S10). The recipe a is created by arranging multiple functional blocks 110 and setting a parameter in each functional block 110, for example. The processing unit 156 generates a signal for requesting registration of the recipe a (hereinafter referred to as the “recipe a registration request”), and the communication unit 160 transmits the recipe a registration request (S12). The recipe a registration request includes the recipe a and identification information of the user A.

The communication unit 410 of the recipe management device 400 receives the recipe a registration request. Upon receiving the recipe a registration request from the communication unit 410, the processing unit 420 generates a signal for confirming whether the recipe a can be registered (hereinafter referred to as the “recipe a registration confirmation”), and the communication unit 410 transmits the recipe a registration confirmation (S14). The recipe a registration confirmation includes the recipe a, identification information of the recipe a, and the identification information of the user A. The identification information of the recipe a is generated in the processing unit 420.

The communication unit 510 of the registration server 500 receives the recipe a registration confirmation. Upon receiving the recipe a registration confirmation from the communication unit 510, the processing unit 520 extracts the recipe a from the recipe a registration confirmation and judges whether or not the recipe a can be registered. For example, when there is no recipe identical to the recipe a in the registered recipes stored in the storage unit 530, the processing unit 520 judges that the recipe a can be registered; when there is a recipe identical to the recipe a in the registered recipes, the processing unit 520 judges that the recipe a cannot be registered. A judgment criterion in the processing unit 520 is not limited thereto. The processing unit 520 then generates a signal that includes the judgment result (hereinafter referred to as the “registration availability response”). The registration availability response includes the identification information of the recipe a and the identification information of the user A. The communication unit 510 transmits the registration availability response (S16).

The communication unit 410 of the recipe management device 400 receives the registration availability response. When the registration availability response received from the communication unit 410 indicates that the recipe a can be registered, the processing unit 420 generates a signal indicating permission to register the recipe a (hereinafter referred to as the “recipe a registration permission”). The recipe a registration permission includes the identification information of the recipe a and the identification information of the user A. The communication unit 410 transmits the recipe a registration permission (S18). On the other hand, when the registration availability response received from the communication unit 410 indicates that the recipe a cannot be registered, the processing unit 420 terminates the processing.

The communication unit 160 of the user device 150a receives the recipe a registration permission. Upon receiving the recipe a registration permission from the communication unit 160, the processing unit 156 generates a signal for providing an instruction for registration of the recipe a (hereinafter referred to as the “recipe a registration”), and the communication unit 160 transmits the recipe a registration (S20). The recipe a registration includes the identification information of the recipe a and the identification information of the user A.

The communication unit 510 of the registration server 500 receives the recipe a registration. Upon receiving the recipe a registration from the communication unit 510, the processing unit 520 registers the recipe a and stores the recipe a, the identification information of the recipe a, and the identification information of the user A in the storage unit 530. The processing unit 520 then generates a signal for performing notification of the completion of the registration of the recipe a (hereinafter referred to as the “registration completion notification”). The communication unit 510 transmits the registration completion notification (S22). The communication unit 410 of the recipe management device 400 receives the registration completion notification. Upon receiving the registration completion notification from the communication unit 410, the processing unit 420 stores the recipe a, the identification information of the recipe a, and the identification information of the user A in the storage unit 430 and starts managing the recipe a (S24).

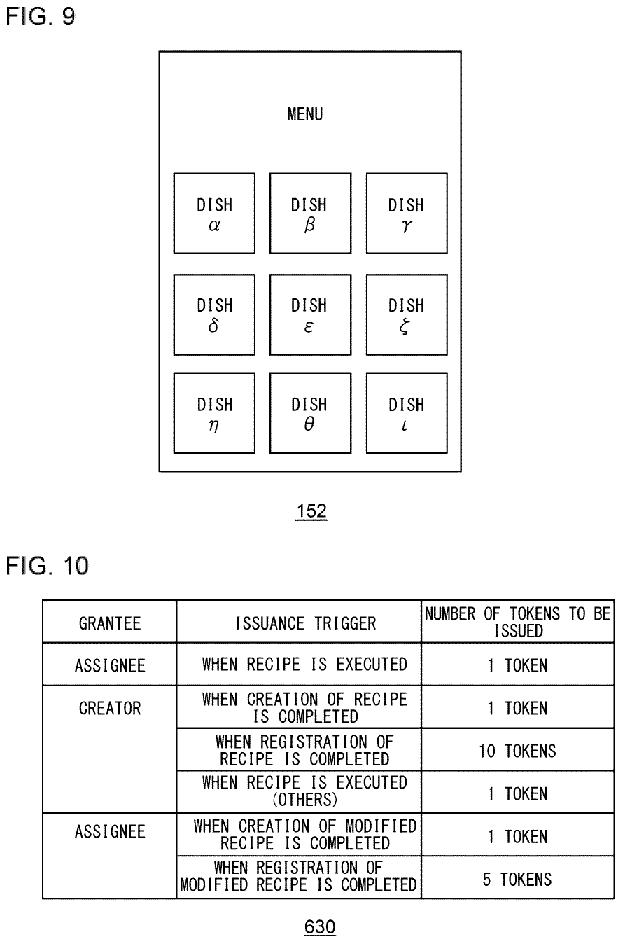

The communication unit 160 of the user device 150b communicates with the recipe management device 400 and receives information on a list of recipes managed by the recipe management device 400, and the processing unit 156 displays a menu screen showing the list of recipes on the display unit 152. FIG. 9 shows a screen displayed on the display unit 152. As shown in the figure, each recipe is displayed as “DISH α” or the like. The description now returns to FIG. 8. The user B searches for a recipe by operating the operation unit 154 while viewing the screen displayed on the display unit 152 (S26). When one recipe is selected by the user B operating the operation unit 154, the communication unit 410 of the recipe management device 400 transmits information regarding the selected recipe as a recipe search result (S28). The recipe search result includes a document of the recipe a, a functional block sequence 120 for the recipe a, and the like.

The communication unit 160 of the user device 150b receives the recipe search result. When deciding to purchase the recipe a, the user B provides an instruction for purchasing the recipe a using the operation unit 154. The processing unit 156 generates a signal for requesting the purchase of the recipe a (hereinafter referred to as the “recipe a purchase request”). The communication unit 160 transmits the recipe a purchase request (S30). The recipe a purchase request includes the identification information of the recipe a and identification information of the user B.

The communication unit 410 of the recipe management device 400 receives the recipe a purchase request. Upon receiving the recipe a purchase request from the communication unit 410, the processing unit 420 adds the identification information of the user B as an assignee (a new owner) to the information regarding the recipe a stored in the storage unit 430. The processing unit 420 also allows the communication unit 410 to transmit the recipe a purchase request (S32) and acquires, from the storage unit 430, information on the user A, who is the creator of the recipe a, and information on the fee for the recipe a. The processing unit 420 then pays the fee for the recipe a to the user device 150a via the communication unit 410 (S34).

The communication unit 510 of the registration server 500 receives the recipe a purchase request. Upon receiving the recipe a purchase request from the communication unit 510, the processing unit 520 acquires the recipe a from the storage unit 530. The communication unit 510 transmits the recipe a to provide the data of the recipe a to the appliance 100d (S36).

The communication unit 140 of the appliance 100d receives the data of the recipe a. The processing unit 146 executes the functional block sequence 120 for the recipe a (S38) and then generates a notification indicating that the execution of the recipe a has been completed (hereinafter referred to as the “recipe a execution notification”). The communication unit 140 transmits the recipe a execution notification (S40).

The communication unit 410 of the recipe management device 400 receives the recipe a execution notification. The recipe a execution notification is an execution notification for communicating the result of cooking the recipe a by the assignee (user B) to whom the recipe a was assigned, and it can be regarded as information indicating contribution to the recipe a for a dish. Upon receiving the recipe a execution notification from the communication unit 410, the processing unit 420 increments the number of times the recipe a has been executed stored in the storage unit 430 (S42). Subsequently, the processing unit 420 determines the number of tokens to be issued, with reference to the storage unit 430. FIG. 10 shows a data structure of a database stored in the storage unit 630. The figure shows the correspondence relationships among the grantee, issuance trigger, and number of tokens to be issued. In this example, since the grantee is the user B (assignee) and the issuance trigger is when the recipe is executed, the processing unit 420 determines the issuance of one token. The description now returns to FIG. 8.

The processing unit 420 generates a token issuance request in response to the incremented number of times of execution. The token issuance request includes the identification information of the recipe a, the history of ownership of the recipe a, the number of times of execution, and the number of tokens to be issued. The history of ownership of the recipe a includes the identification information of the user A and the identification information of the user B (grantee of the token). The token issuance request also includes the identification information of the user device 150b. This corresponds to granting a token to the assignee (user B) when the number of times of execution increases. The communication unit 410 transmits the token issuance request (S44).

The communication unit 610 of the token management server 600 receives the token issuance request. Upon receiving the token issuance request from the communication unit 610, the processing unit 620 stores information included in the token issuance request in the storage unit 630 and issues a token, such as one token. Since a publicly-known technique may be used for the issuance of the token, a specific description thereof is omitted here. The communication unit 610 transmits the token to the user device 150b (S46).

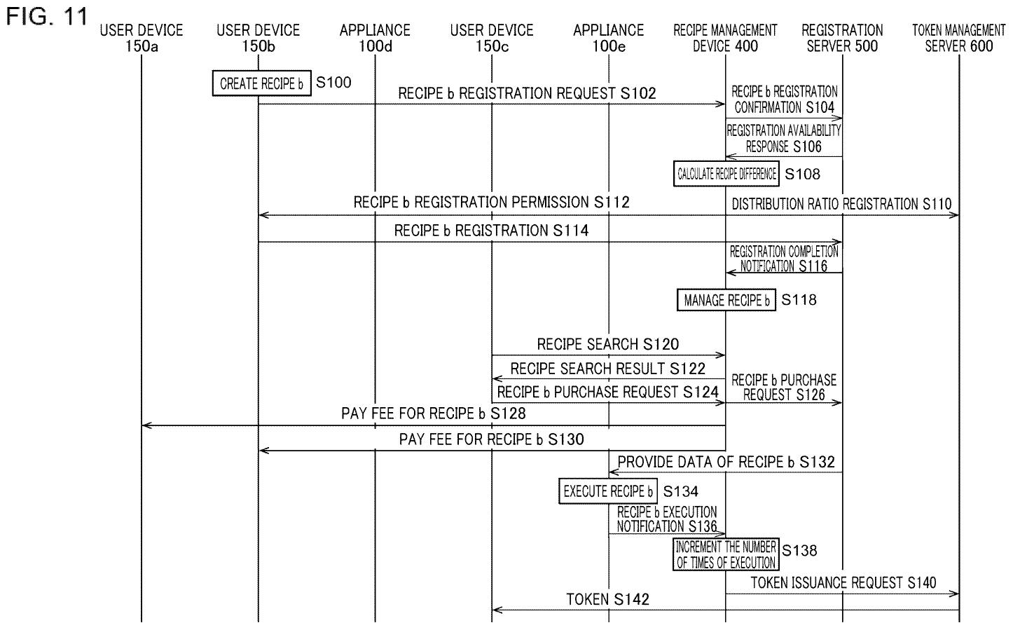

FIG. 11 is a sequential diagram that shows the subsequent procedure of the first processing example performed by the information processing system 1500. This shows the processing following FIG. 8. When the operation unit 154 of the user device 150b receives a corresponding operation by the user B, the processing unit 156 creates a new recipe (hereinafter referred to as a “recipe b”) obtained by modifying the recipe a (S100). The recipe b is created, for example, by changing multiple functional blocks 110 included in the recipe a or changing a parameter in each functional block 110. The processing unit 156 generates a signal for requesting registration of the recipe b (hereinafter referred to as the “recipe b registration request”), and the communication unit 160 transmits the recipe b registration request (S102). The recipe b registration request includes the recipe b and the identification information of the user B.

The communication unit 410 of the recipe management device 400 receives the recipe b registration request. Upon receiving the recipe b registration request from the communication unit 410, the processing unit 420 generates a signal for confirming whether the recipe b can be registered (hereinafter referred to as the “recipe b registration confirmation”), and the communication unit 410 transmits the recipe b registration confirmation (S104). The recipe b registration confirmation includes the recipe b, identification information of the recipe b, and the identification information of the user B. The identification information of the recipe b is generated in the processing unit 420.

The communication unit 510 of the registration server 500 receives the recipe b registration confirmation. Upon receiving the recipe b registration confirmation from the communication unit 510, the processing unit 520 extracts the recipe b from the recipe b registration confirmation and judges whether or not the recipe b can be registered. The processing unit 520 then generates a registration availability response. The registration availability response includes the identification information of the recipe b and the identification information of the user B. The communication unit 510 transmits the registration availability response (S106).

The communication unit 410 of the recipe management device 400 receives the registration availability response. When the registration availability response received from the communication unit 410 indicates that the recipe a can be registered, the processing unit 420 specifies that the user B has purchased the recipe a in the past based on the information stored in the storage unit 430. The processing unit 420 then calculates the difference between the recipe b and the recipe a (S108). Since a publicly-known technique may be used for the calculation of the difference, a specific description thereof is omitted here. Based on the result of difference calculation, the processing unit 420 determines the distribution ratio between the user A and the user B when the recipe b is sold. The smaller the difference, the larger the distribution ratio of the user A; the larger the difference, the larger the distribution ratio of the user B. The processing unit 420 then stores the distribution ratio in the storage unit 430 and generates a signal for registering the distribution ratio (hereinafter referred to as the “distribution ratio registration”). The distribution ratio registration includes the distribution ratio, the identification information of the recipe b, the identification information of the user A, and the identification information of the user B. The communication unit 410 transmits the distribution ratio registration (S110). The communication unit 610 of the token management server 600 receives the distribution ratio registration. Upon receiving the distribution ratio registration from the communication unit 610, the processing unit 620 registers the distribution ratio by storing the distribution ratio in the storage unit 630.

When the registration availability response received from the communication unit 410 indicates that the recipe b can be registered, the processing unit 420 generates a signal indicating permission to register the recipe b (hereinafter referred to as the “recipe b registration permission”). The recipe b registration permission includes the identification information of the recipe b and the identification information of the user B. The communication unit 410 transmits the recipe b registration permission (S112). Meanwhile, when the registration availability response received from the communication unit 410 indicates that the recipe b cannot be registered, the processing unit 420 terminates the processing.

The communication unit 160 of the user device 150b receives the recipe b registration permission. Upon receiving the recipe b registration permission from the communication unit 160, the processing unit 156 generates a signal for providing an instruction for registration of the recipe b (hereinafter referred to as the “recipe b registration”), and the communication unit 160 transmits the recipe b registration (S114). The recipe b registration includes the identification information of the recipe b and the identification information of the user B.

The communication unit 510 of the registration server 500 receives the recipe b registration. Upon receiving the recipe b registration from the communication unit 510, the processing unit 520 registers the recipe b and stores the recipe b, the identification information of the recipe b, and the identification information of the user B in the storage unit 530. The processing unit 520 then generates the registration completion notification for the recipe b. The communication unit 510 transmits the registration completion notification (S116). The communication unit 410 of the recipe management device 400 receives the registration completion notification. Upon receiving the registration completion notification from the communication unit 410, the processing unit 420 stores the recipe b, the identification information of the recipe b, and the identification information of the user B in the storage unit 430 and starts managing the recipe b (S118).

The communication unit 160 of the user device 150c communicates with the recipe management device 400 and receives information on a list of recipes managed by the recipe management device 400, and the processing unit 156 displays a menu screen showing the list of recipes on the display unit 152. The menu screen is shown as FIG. 9. The user C searches for a recipe by operating the operation unit 154 while viewing the screen displayed on the display unit 152 (S120). When one recipe is selected by the user C operating the operation unit 154, the communication unit 410 of the recipe management device 400 transmits information regarding the selected recipe as a recipe search result (S122). The recipe search result includes a document of the recipe b, a functional block sequence 120 for the recipe b, and the like.

The communication unit 160 of the user device 150c receives the recipe search result. When deciding to purchase the recipe b, the user C provides an instruction for purchasing the recipe b using the operation unit 154. The processing unit 156 generates a signal for requesting the purchase of the recipe b (hereinafter referred to as the “recipe b purchase request”). The communication unit 160 transmits the recipe b purchase request (S124). The recipe b purchase request includes the identification information of the recipe b and identification information of the user C.

The communication unit 410 of the recipe management device 400 receives the recipe b purchase request. Upon receiving the recipe b purchase request from the communication unit 410, the processing unit 420 adds the identification information of the user C as an assignee (a new owner) to the information regarding the recipe b stored in the storage unit 430. The processing unit 420 also allows the communication unit 410 to transmit the recipe c purchase request (S126) and acquires, from the storage unit 430, information on the user A, information on the user B, and information on the fee for the recipe b for which the distribution ratio has been determined. The processing unit 420 then pays the fee for the recipe b (for the user A) to the user device 150a via the communication unit 410 (S128) and pays the fee for the recipe b (for the user B) to the user device 150b via the communication unit 410 (S130).

The communication unit 510 of the registration server 500 receives the recipe b purchase request. Upon receiving the recipe b purchase request from the communication unit 510, the processing unit 520 acquires the recipe b from the storage unit 530. The communication unit 510 transmits the recipe b to provide the data of the recipe b to the appliance 100e (S132).

The communication unit 140 of the appliance 100e receives the data of the recipe b. The processing unit 146 executes the functional block sequence 120 for the recipe b (S134) and then generates a notification indicating that the execution of the recipe b has been completed (hereinafter referred to as the “recipe b execution notification”). The communication unit 140 transmits the recipe b execution notification (S136).

The communication unit 410 of the recipe management device 400 receives the recipe b execution notification. The recipe b execution notification is an execution notification for communicating the result of cooking the recipe b by the assignee (user C) to whom the recipe b was assigned, and it can be regarded as information indicating contribution to the recipe b for a dish. Upon receiving the recipe b execution notification from the communication unit 410, the processing unit 420 increments the number of times the recipe b has been executed stored in the storage unit 430 (S138). Subsequently, the processing unit 420 determines the number of tokens to be issued, with reference to the storage unit 430.

The processing unit 420 generates a token issuance request in response to the incremented number of times of execution. The token issuance request includes the identification information of the recipe b, the history of ownership of the recipe b, the number of times of execution, and the number of tokens to be issued. The history of ownership of the recipe b includes the identification information of the user B and the identification information of the user C (grantee of the token). The token issuance request also includes the identification information of the user device 150c. This corresponds to granting a token to the assignee (user C) when the number of times of execution increases. The communication unit 410 transmits the token issuance request (S140).

The communication unit 610 of the token management server 600 receives the token issuance request. Upon receiving the token issuance request from the communication unit 610, the processing unit 620 stores information included in the token issuance request in the storage unit 630 and issues a token. The communication unit 610 transmits the token to the user device 150c (S142).

The tokens accumulated by the users (user B, user C) can be used, for example, as follows. The tokens are used as money and can be used to purchase recipes. By using tokens, it is possible to participate in the review on the originality and allocation of new recipes obtained through modification. By using tokens, it is possible to eat dishes cooked from recipes in the information processing system 1500. By using tokens, it is possible to become an administrator or a moderator of the information processing system 1500. By using tokens, it is possible to obtain the right to vote to determine the distribution ratio.

### (4) Second Processing Example

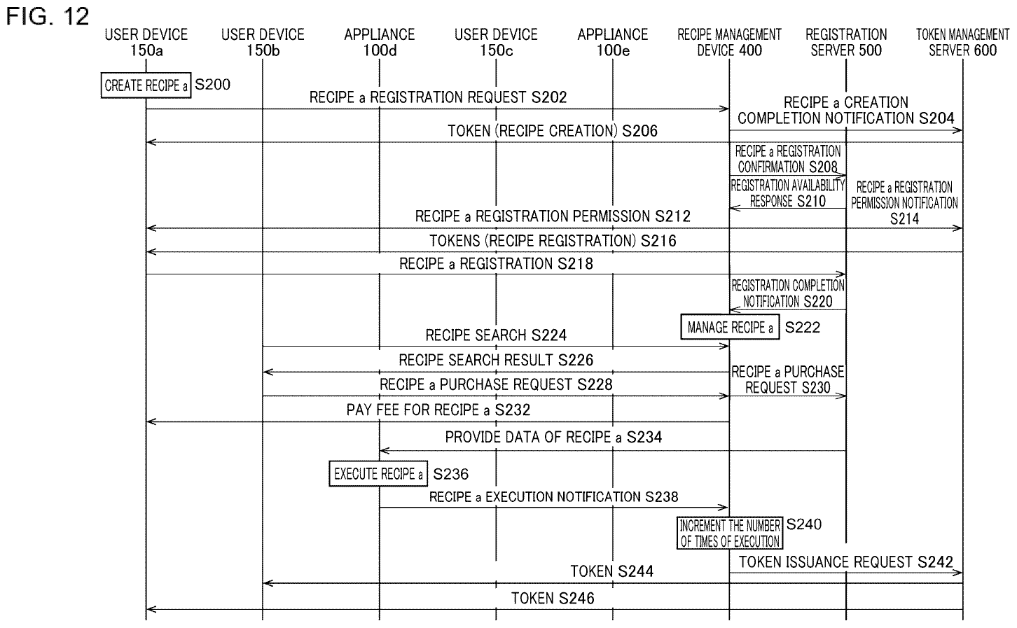

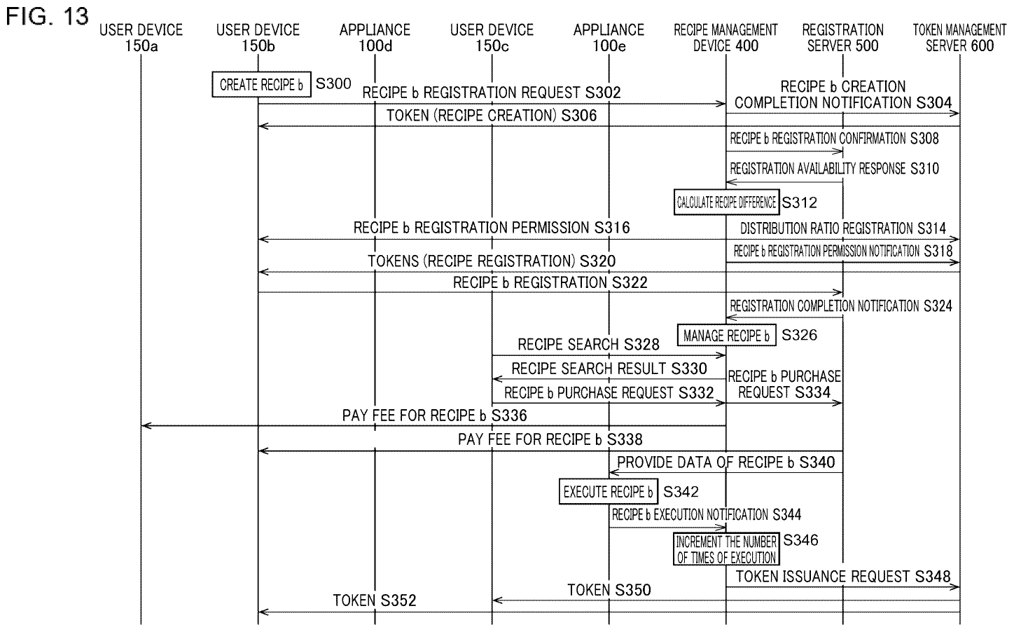

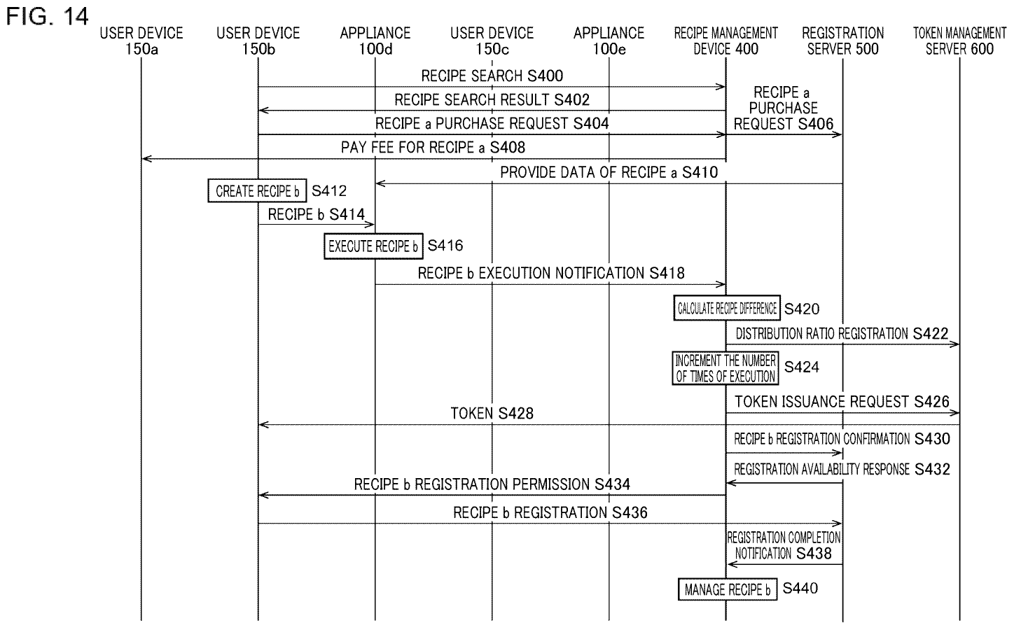

In the first processing example, a token is issued when an assignee of a recipe has cooked the recipe. Meanwhile, although the second processing example is performed with the same procedure as the first processing example, a token is also issued in a case other than the case where the assignee of the recipe has cooked the recipe. In other words, in the second processing example, there are more token issuance triggers than in the first processing example. In the following, the second processing example performed by the information processing system 1500 will be described while using FIGS. 12 and 13.

FIG. 12 is a sequential diagram that shows the procedure of the second processing example performed by the information processing system 1500. The steps 200 and 202 are identical to the steps 10 and 12 in FIG. 8. The communication unit 410 of the recipe management device 400 receives the recipe a registration request. The recipe a registration request is information for requesting registration of the recipe a created by the creator (user A) and can be regarded as information indicating contribution to the recipe a for a dish. Upon receiving the recipe a registration request from the communication unit 410, the processing unit 420 determines the number of tokens to be issued, with reference to the storage unit 430. As shown in FIG. 10, since the grantee is the user A (creator) and the issuance trigger is when the creation of the recipe is completed, the processing unit 420 determines the issuance of one token.

In order to request the token issuance request in response to the creation of the recipe a, the processing unit 420 generates a signal indicating that the creation of the recipe a has been completed (hereinafter referred to as the “recipe a creation completion notification”). The recipe a creation completion notification includes the identification information of the user A (grantee of the token), the identification information of the recipe a, and the number of tokens to be issued. The recipe a creation completion notification also includes the identification information of the user device 150a. The identification information of the recipe a is generated in the processing unit 420. This corresponds to granting a token to the creator (user A) when the recipe a registration request is received. The communication unit 410 transmits the recipe a creation completion notification (S204).

The communication unit 610 of the token management server 600 receives the recipe a creation completion notification. Upon receiving the recipe a creation completion notification from the communication unit 610, the processing unit 620 stores information included in the recipe a creation completion notification in the storage unit 630 and issues a token, such as one token. The communication unit 610 transmits the token to the user device 150a (S206). The steps 208 through 212 are identical to the steps 14 through 18 in FIG. 8.

When the registration availability response received from the communication unit 410 indicates that the recipe a can be registered, the processing unit 420 of the recipe management device 400 determines the number of tokens to be issued, with reference to the storage unit 430. As shown in FIG. 10, since the grantee is the user A (creator) and the issuance trigger is when the registration of the recipe is completed, the processing unit 420 determines the issuance of ten tokens.

In order to request the token issuance request in response to the registration of the recipe a, the processing unit 420 generates a signal indicating that the registration of the recipe a has been permitted (hereinafter referred to as the “recipe a registration permission notification”). The recipe a registration permission notification includes the identification information of the user A (grantee of the tokens), the identification information of the recipe a, and the number of tokens to be issued. The recipe a registration permission notification also includes the identification information of the user device 150a. This corresponds to granting a token to the creator (user A) when the registration of the recipe a indicated in the recipe a registration request is permitted. The communication unit 410 transmits the recipe a registration permission notification (S214).

The communication unit 610 of the token management server 600 receives the recipe a registration permission notification. Upon receiving the recipe a registration permission notification from the communication unit 610, the processing unit 620 stores information included in the recipe a registration permission notification in the storage unit 630 and issues a token, such as ten tokens. The communication unit 610 transmits the tokens to the user device 150a (S216).

The steps 218 through 242 are identical to the steps 20 through 44 in FIG. 8. In the process, the processing unit 420 of the recipe management device 400 determines the number of tokens to be issued, with reference to the storage unit 430. The processing unit 420 determines the issuance of one token for the case where the grantee is the user B (assignee) and the issuance trigger is when the recipe is executed and also determines the issuance of one token for the case where the grantee is the user A (creator) and the issuance trigger is when the recipe is executed. In other words, when the number of times of execution increases, the creator of the recipe a (user A) is also granted a token.

The communication unit 610 of the token management server 600 receives the token issuance request. Upon receiving the token issuance request from the communication unit 610, the processing unit 620 stores information included in the token issuance request in the storage unit 630 and issues a token for the assignee (user B), such as one token. The communication unit 610 transmits the token to the user device 150b (S244). The processing unit 620 also issues a token for the creator (user A), such as one token. The communication unit 610 transmits the token to the user device 150a (S246).

FIG. 13 is a sequential diagram that shows the subsequent procedure of the second processing example performed by the information processing system 1500. The steps 300 and 302 are identical to the steps 100 and 102 in FIG. 11. The communication unit 410 of the recipe management device 400 receives the recipe b registration request. The recipe b registration request is information for requesting registration of the recipe b obtained through modification by the assignee (user B), to whom the recipe a was assigned, and can be regarded as information indicating contribution to the recipe b for a dish. Upon receiving the recipe b registration request from the communication unit 410, the processing unit 420 determines the number of tokens to be issued, with reference to the storage unit 430. As shown in FIG. 10, since the grantee is the user B (assignee) and the issuance trigger is when the creation of the modified recipe is completed, the processing unit 420 determines the issuance of one token.

In order to request the token issuance request in response to the creation of the recipe b, the processing unit 420 generates a signal indicating that the creation of the recipe b has been completed (hereinafter referred to as the “recipe b creation completion notification”). The recipe b creation completion notification includes the identification information of the user B (grantee of the token), the identification information of the recipe b, and the number of tokens to be issued. The recipe b creation completion notification also includes the identification information of the user device 150b. The identification information of the recipe b is generated in the processing unit 420. This corresponds to granting a token to the assignee (user B) when the recipe b registration request is received. The communication unit 410 transmits the recipe b creation completion notification (S304).

The communication unit 610 of the token management server 600 receives the recipe b creation completion notification. Upon receiving the recipe b creation completion notification from the communication unit 610, the processing unit 620 stores information included in the recipe b creation completion notification in the storage unit 630 and issues a token, such as one token. The communication unit 610 transmits the token to the user device 150b (S306). The steps 308 through 316 are identical to the steps 104 through 112 in FIG. 11.

When the registration availability response received from the communication unit 410 indicates that the recipe b can be registered, the processing unit 420 of the recipe management device 400 determines the number of tokens to be issued, with reference to the storage unit 430. As shown in FIG. 10, since the grantee is the user B (assignee) and the issuance trigger is when the registration of the modified recipe is completed, the processing unit 420 determines the issuance of five tokens.

In order to request the token issuance request in response to the registration of the recipe b, the processing unit 420 generates a signal indicating that the registration of the recipe b has been permitted (hereinafter referred to as the “recipe b registration permission notification”). The recipe b registration permission notification includes the identification information of the user B (grantee of the tokens), the identification information of the recipe b, and the number of tokens to be issued. The recipe b registration permission notification also includes the identification information of the user device 150b. This corresponds to granting a token to the assignee (user B) when the registration of the recipe b indicated in the recipe b registration request, which is for requesting registration of the recipe b obtained through modification by the assignee (user B) to whom the recipe a was assigned, is permitted. The communication unit 410 transmits the recipe b registration permission notification (S318).

The communication unit 610 of the token management server 600 receives the recipe b registration permission notification. Upon receiving the recipe b registration permission notification from the communication unit 610, the processing unit 620 stores information included in the recipe b registration permission notification in the storage unit 630 and issues a token, such as five tokens. The communication unit 610 transmits the tokens to the user device 150b (S320).

The steps 322 through 348 are identical to the steps 114 through 140 in FIG. 11. In the process, the processing unit 420 of the recipe management device 400 determines the number of tokens to be issued, with reference to the storage unit 430. The processing unit 420 determines the issuance of one token for the case where the grantee is the user C (assignee) and the issuance trigger is when the recipe is executed and also determines the issuance of one token for the case where the grantee is the user B (creator) and the issuance trigger is when the recipe is executed. In other words, when the number of times of execution increases, the creator of the recipe b (user B) is also granted a token.

The communication unit 610 of the token management server 600 receives the token issuance request. Upon receiving the token issuance request from the communication unit 610, the processing unit 620 stores information included in the token issuance request in the storage unit 630 and issues a token for the assignee (user C), such as one token. The communication unit 610 transmits the token to the user device 150c (S350). The processing unit 620 also issues a token for the creator (user B), such as one token. The communication unit 610 transmits the token to the user device 150b (S352).

When the recipe b is executed after the recipe b is registered, the number of times the recipe b has been executed is incremented, and a token for the recipe b is issued; however, the number of times the recipe a has been executed is not incremented, and a token for the recipe a is not issued. Meanwhile, when the recipe a is executed after the recipe b is registered, the number of times the recipe a has been executed is incremented, and a token for the recipe a is issued.

While the tokens are issued in various situations in the second processing example, the type of a token may be changed depending on how the token is issued (issuance trigger). Also, when the type of a token is changed, the privilege granted by the token may also be changed. The privileges granted by the tokens include the right to speak and the right to act.

### (5) Third Processing Example

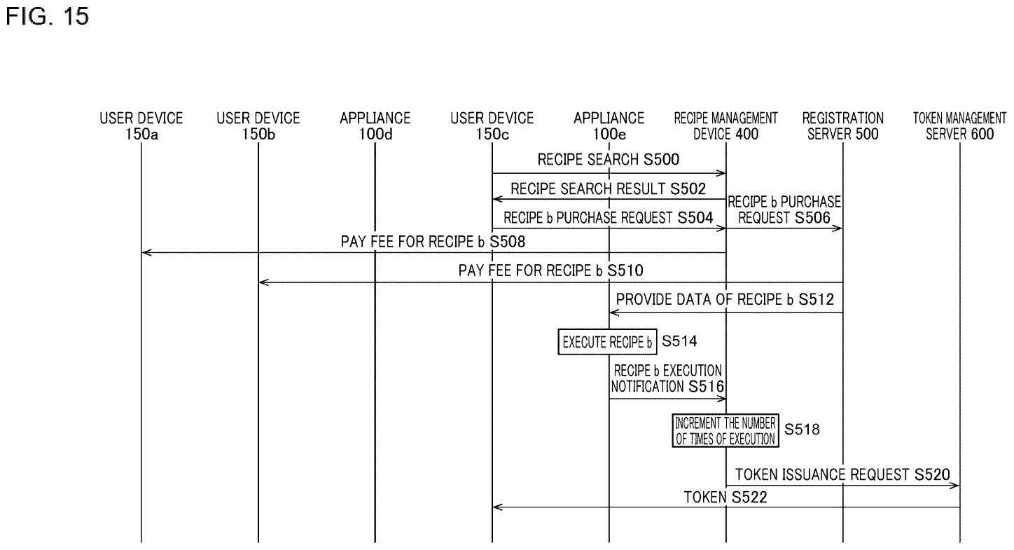

In the first and second processing examples, the user B creates the recipe b by modifying the recipe a and requests the registration of the recipe b. However, when the amount of modification is small, it can be said that the recipe b is not a modification of the recipe a but obtained merely by adjusting the recipe a. The user B can cook the recipe b with an appliance 100 without requesting the registration of the recipe b. The third processing example relates to such a situation. In the following, the third processing example performed by the information processing system 1500 will be described while using FIGS. 14 and 15.

FIG. 14 is a sequential diagram that shows the procedure of the third processing example performed by the information processing system 1500. It is assumed that the steps 10 through 24 of the first processing example have been executed prior to the processing shown in FIG. 14. The steps 400 through 410 are identical to the steps 26 through 36 in FIG. 8. When the operation unit 154 of the user device 150b receives a corresponding operation by the user B, the processing unit 156 creates the recipe b from the recipe a (S412). As described previously, the user B considers that the recipe b was created merely by adjusting the recipe a. The communication unit 160 transmits the data of the recipe b (S414).

The communication unit 140 of the appliance 100d receives the data of the recipe b. The processing unit 146 executes the functional block sequence 120 for the recipe b (S416) and then generates the recipe b execution notification. The communication unit 140 transmits the recipe b execution notification (S418). The recipe b execution notification includes the recipe b.

The communication unit 410 of the recipe management device 400 receives the recipe b execution notification. The processing unit 420 acquires the recipe b from the recipe b execution notification. The processing unit 420 also confirms, from the data stored in the storage unit 430, that the user B has purchased the recipe a. The processing unit 420 then calculates the difference between the recipe b and the recipe a (S420). Based on the result of difference calculation, the processing unit 420 determines the distribution ratio between the user A and the user B when the recipe b is sold. The processing unit 420 then stores the distribution ratio in the storage unit 430 and generates a signal for registering the distribution ratio (hereinafter referred to as the “distribution ratio registration”). The communication unit 410 transmits the distribution ratio registration (S422). The communication unit 610 of the token management server 600 receives the distribution ratio registration. Upon receiving the distribution ratio registration from the communication unit 610, the processing unit 620 registers the distribution ratio by storing the distribution ratio in the storage unit 630. Upon receiving the recipe b execution notification from the communication unit 410, the processing unit 420 increments the number of times the recipe a has been executed stored in the storage unit 430 (S424). Subsequently, the processing unit 420 determines the number of tokens to be issued, with reference to the storage unit 430. The processing unit 420 generates a token issuance request in response to the incremented number of times of execution. The communication unit 410 transmits the token issuance request (S426).

The communication unit 610 of the token management server 600 receives the token issuance request. Upon receiving the token issuance request from the communication unit 610, the processing unit 620 stores information included in the token issuance request in the storage unit 630 and issues a token. The communication unit 610 transmits the token to the user device 150c (S428). The processing unit 420 of the recipe management device 400 generates the recipe b registration confirmation, and the communication unit 410 transmits the recipe b registration confirmation (S430).

The communication unit 510 of the registration server 500 receives the recipe b registration confirmation. Upon receiving the recipe b registration confirmation from the communication unit 510, the processing unit 520 extracts the recipe b from the recipe b registration confirmation and judges whether or not the recipe b can be registered. The processing unit 520 then generates the registration availability response. The communication unit 510 transmits the registration availability response (S432).

The communication unit 410 of the recipe management device 400 receives the registration availability response. When the registration availability response received from the communication unit 410 indicates that the recipe b can be registered, the processing unit 420 generates the recipe b registration permission. The communication unit 410 transmits the recipe b registration permission (S434).

The communication unit 160 of the user device 150b receives the recipe b registration permission. Upon receiving the recipe b registration permission from the communication unit 160, the processing unit 156 generates the recipe b registration, and the communication unit 160 transmits the recipe b registration (S436).

The communication unit 510 of the registration server 500 receives the recipe b registration. Upon receiving the recipe b registration from the communication unit 510, the processing unit 520 registers the recipe b. The processing unit 520 then generates the registration completion notification for the recipe b. The communication unit 510 transmits the registration completion notification (S438). The communication unit 410 of the recipe management device 400 receives the registration completion notification. Upon receiving the registration completion notification from the communication unit 410, the processing unit 420 starts managing the recipe b (S440).

FIG. 15 is a sequential diagram that shows the subsequent procedure of the third processing example performed by the information processing system 1500. The steps 500 through 522 are identical to the steps 120 through 142 in FIG. 11. As described above, instead of cooking the purchased recipe a as it is, the user B cooks the recipe b obtained by altering the recipe a with daily ingenuity. By being automatically evaluated without the user B's intention, the recipe b is registered as a new recipe obtained by modifying the recipe a. At the time, the user B considers that he or she contributes to the recipe a by cooking the recipe a. Therefore, at the time of the first execution of the recipe b, a token for the execution of the recipe a is issued as the number of times the recipe a has been executed increases. After the recipe b is registered, a token for the execution of the recipe b is issued when the user C, who is an assignee of the recipe b, cooks the recipe b. Meanwhile, after the recipe b is registered, a token for the execution of the recipe a is not issued when the user C as the assignee of the recipe b cooks the recipe b.

### (6) Fourth Processing Example

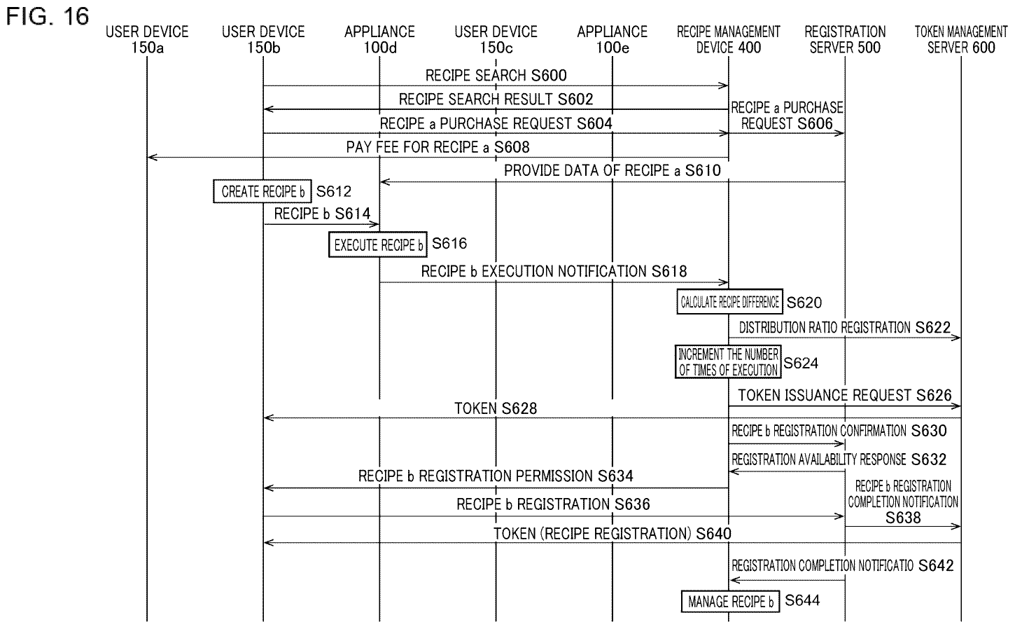

In the fourth processing example, the situation is similar to that in the third processing example; however, compared to the third processing example, a token is also issued when the recipe b is registered. In other words, in the fourth processing example, there are more token issuance triggers than in the third processing example. In the following, the fourth processing example performed by the information processing system 1500 will be described while using FIG. 16.

FIG. 16 is a sequential diagram that shows the procedure of the fourth processing example performed by the information processing system 1500. The steps 600 through 636 are identical to the steps 400 through 436 in FIG. 14. Upon registering the recipe b, the processing unit 520 of the registration server 500 generates a signal for performing notification of the completion of the registration of the recipe b (hereinafter referred to as the “recipe b registration completion notification”), and the communication unit 510 transmits the recipe b registration completion notification (S638).

The communication unit 610 of the token management server 600 receives the recipe b registration completion notification. Upon receiving the recipe b registration completion notification from the communication unit 610, the processing unit 620 stores information included in the recipe b registration completion notification in the storage unit 630 and issues a token. The communication unit 610 transmits the token to the user device 150b (S640). The steps 642 and 644 are identical to the steps 438 and 440 in FIG. 14.

### (7) Fifth Processing Example

In the examples described above, when a recipe is executed, when a recipe is created (modified), or when a recipe is registered, it is considered as a contribution to the recipe, and a token is issued. In the fifth processing example, a token is issued in a case other than those cases when it is considered that a contribution to a recipe has been made.

In this example, a situation is assumed where a user D, who does not create or purchase any recipe, uses a user device 150d (not illustrated) in FIG. 5. Based on an operation by the user D provided on the operation unit 154, the user device 150d communicates with the recipe management device 400 to display the menu screen (FIG. 9) on the display unit 152. By operating the operation unit 154, the user D selects the dish α on the menu screen. Subsequently, the processing unit 156 displays a detailed screen for the dish α on the display unit 152.

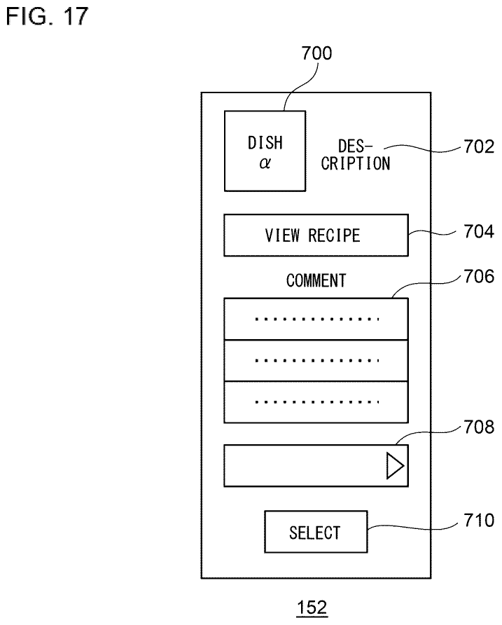

FIG. 17 shows a screen displayed on the display unit 152 in the fifth processing example performed by the user device 150, such as a detailed screen for the dish α. In an upper portion of the detailed screen, a photograph 700 of the dish and a recipe description 702 are arranged. Below these, a VIEW RECIPE button 704 is disposed. When the user D operates the operation unit 154 to select the VIEW RECIPE button 704, the processing unit 156 displays the recipe for the dish α (hereinafter referred to as a “recipe c”). The recipe may be shown as a document or as a functional block sequence 120. In a comment section 706, comments posted by various users using the user devices 150 are displayed. The comments include, for example, a comment about the recipe c, a question about the recipe c, and an answer to a question. When posting a comment, the user D enters the comment in an entry field 708. Below the entry field 708, a SELECT button 710 is disposed. When the user D operates the operation unit 154 to select the SELECT button 710, the processing unit 156 creates a purchase request for the recipe c.

In the fifth processing example, the recipe management device 400 determines the grant of tokens to a user who posted a comment, a user who posted a question, and a user who posted an answer, and the token management server 600 issues the tokens to the users. In other words, the comments, questions, and answers are messages to the recipe and information indicating contribution. Also, when a message is received, a token is granted to the sender of the message. Here, a token may not be issued only for posting of a comment providing information, and a token may be issued to the user who posted the comment providing the information when a comment for reaction or evaluation to the information provision is posted.

On the detailed screen shown in FIG. 17, a button used to enter an evaluation (good, bad) for the recipe may be disposed. When the user D operates the operation unit 154 to select a good button or a bad button, the processing unit 156 generates a signal including the evaluation result (hereinafter referred to as an “evaluation signal”). The communication unit 160 transmits the evaluation signal. When the communication unit 410 of the recipe management device 400 receives the evaluation signal, the processing unit 420 determines the grant of a token to the user D.

On the detailed screen shown in FIG. 17, a button used to place the recipe in a wish list or a cart may be disposed. When the user D operates the operation unit 154 to select such a button, the processing unit 156 generates a signal including the processing result (hereinafter referred to as a “result signal”). The communication unit 160 transmits the result signal. When the communication unit 410 of the recipe management device 400 receives the result signal, the processing unit 420 determines the grant of a token to the user D.

Further, if the same user posts comments for one recipe multiple times, an additional token may be granted to the user. Also, when a user posts a comment or registers a recipe at a specific time, such as during a predetermined period of time before Christmas, an additional token may be granted to the user. Also, the shorter the period of time between when a recipe is registered and when a comment is posted, the more tokens may be granted to the user who registered the comment. Also, if there is no response for a certain period of time to a recipe for which a token has been issued, the recipe may be deleted. Also, the recipes may be registered without the review. Further, when a predetermined user or store modifies or purchases a recipe, the recipe management device 400 may grant an additional token to the user or store.

Recipes, comments, and the like may be evaluated with “Like” or the like. In this case, a token may be granted to a recipe, comment, or the like to which a predetermined number or more “Likes” have been given. In order to prevent abuse, the evaluation with “Like” or the like may be limited to once per user.

The recipe management device 400 may hold rules for issuing tokens based on combinations of recipes. Accordingly, when a user cooks a combination of different recipes, a token may be issued as determined in advance by the recipe management device 400. Also, besides cooking a recipe, by taking a picture of the cooked recipe and posting it from a user device 150, an additional token may be issued. Also, each user device 150 may input attribute information of the user using a hashtag, for example. When a user comments on a recipe of another user having the same attribute information, more tokens may be issued compared to the case of commenting on a recipe of a user having different attributes.

This configuration may be implemented by a central processing unit (CPU) or memory of any given computer, a large scale integration (an LSI), or the like in terms of hardware, and by a memory-loaded program or the like in terms of software. In the present embodiment is shown a functional block configuration realized by cooperation thereof. Therefore, it will be understood by those skilled in the art that these functional blocks may be implemented in a variety of forms by hardware only or a combination of hardware and software.

According to the present embodiment, since information indicating contribution to a recipe for a dish is received before a token for the recipe is granted, actions that contribute to the recipe can be evaluated. Also, since a creator is granted a token when the registration request for requesting registration of a recipe created by the creator is received, motivation to create recipes can be improved. Also, since the creator is granted a token when the registration of the recipe indicated in the registration request is permitted, motivation to register recipes can be improved. Also, since the creator is granted a token when the number of times an assignee, to whom the recipe was assigned, has cooked the recipe increases, motivation to create recipes that the assignee will want to cook can be improved.

Also, since an assignee is granted a token when the number of times the assignee to whom a recipe was assigned has cooked the recipe increases, motivation to cook recipes can be improved. Also, since an assignee is granted a token when the registration request for requesting registration of a modified recipe provided by the assignee to whom a recipe was assigned is received, motivation to alter recipes on a daily basis can be improved. Also, since an assignee is granted a token when the registration of a recipe indicated in the registration request is permitted, motivation to alter recipes on a daily basis can be improved. Further, when a message for a recipe is received, the sender of the message is granted a token, so that motivation to post messages can be improved.

The outline of one embodiment of the present disclosure is as follows.

### Item 1

A granting method, including:
receiving, via a network, information indicating contribution to a recipe for a dish; and
granting a point for the recipe after receiving the information indicating contribution.

### Item 2

The granting method according to Item 1,
wherein the information indicating contribution is a registration request for requesting registration of a recipe created by a creator, and
wherein, in the granting, the point is granted to the creator when the registration request is received.

### Item 3

The granting method according to Item 1 or 2,
wherein the information indicating contribution is a registration request for requesting registration of a recipe created by a creator, and
wherein, in the granting, the point is granted to the creator when registration of the recipe indicated in the registration request is permitted.

### Item 4

The granting method according to any one of Items 1 through 3,
wherein the information indicating contribution is an execution notification for communicating the result of cooking the recipe by an assignee to whom the recipe was assigned, and the granting method further includes increasing the number of times of execution when the execution notification is received, and
wherein, in the granting, a point is granted to the creator of the recipe when the number of times of execution is increased.

### Item 5

The granting method according to any one of Items 1 through 4,
wherein the information indicating contribution is an execution notification for communicating the result of cooking the recipe by an assignee to whom the recipe was assigned, and the granting method further includes increasing the number of times of execution when the execution notification is received, and
wherein, in the granting, a point is granted to the assignee when the number of times of execution is increased.

### Item 6

The granting method according to any one of Items 1 through 5,
wherein the information indicating contribution is a registration request for requesting registration of a modified recipe provided by an assignee to whom the recipe was assigned, and
wherein, in the granting, the point is granted to the assignee when the registration request is received.

### Item 7

The granting method according to any one of Items 1 through 6,
wherein the information indicating contribution is a registration request for requesting registration of a modified recipe provided by an assignee to whom the recipe was assigned, and
wherein, in the granting, the point is granted to the assignee when registration of the recipe indicated in the registration request is permitted.

### Item 8

The granting method according to any one of Items 1 through 7,
wherein the information indicating contribution is a message for the recipe, and
wherein, in the granting, the point is granted to the sender of the message when the message is received.

### Item 9

An information processing device, including: a communication unit that receives, via a network, information indicating contribution to a recipe for a dish; and
a processing unit that grants a point for the recipe after the communication unit receives the information indicating contribution.

### Item 10

A program causing a computer to implement:
receiving, via a network, information indicating contribution to a recipe for a dish; and
granting a point for the recipe after receiving the information indicating contribution.

The present disclosure has been described with reference to an embodiment. The embodiment is intended to be illustrative only, and it will be obvious to those skilled in the art that various modifications to a combination of constituting elements or processes in the embodiment could be developed and that such modifications also fall within the scope of the present disclosure.

The recipe management device 400 in the present embodiment determines the grant of a token when the number of times a recipe has been executed increases. However, the application is not limited thereto, and the recipe management device 400 may determine the grant of a token only when the number of times a recipe has been executed reaches two or more, for example. This modification improves reliability of the tokens.

The recipe management device 400 in the present embodiment grants tokens. However, the application is not limited thereto, and the recipe management device 400 may grant points, for example. Tokens can be regarded as an example of points. This modification allows greater flexibility in configuration.

What is claimed is:

1. A granting method, comprising:
receiving, via a network, information indicating contribution to a recipe for a dish; and
granting a point for the recipe after receiving the information indicating contribution.

2. The granting method according to claim 1,
wherein the information indicating contribution is a registration request for requesting registration of a recipe created by a creator, and
wherein, in the granting, the point is granted to the creator when the registration request is received.

3. The granting method according to claim 1,
wherein the information indicating contribution is a registration request for requesting registration of a recipe created by a creator, and
wherein, in the granting, the point is granted to the creator when registration of the recipe indicated in the registration request is permitted.

4. The granting method according to claim 1,
wherein the information indicating contribution is an execution notification for communicating the result of cooking the recipe by an assignee to whom the recipe was assigned, and the granting method further comprises increasing the number of times of execution when the execution notification is received, and
wherein, in the granting, a point is granted to the creator of the recipe when the number of times of execution is increased.

5. The granting method according to claim 1,
wherein the information indicating contribution is an execution notification for communicating the result of cooking the recipe by an assignee to whom the recipe was assigned, and the granting method further comprises increasing the number of times of execution when the execution notification is received, and
wherein, in the granting, a point is granted to the assignee when the number of times of execution is increased.

6. The granting method according to claim 1,
wherein the information indicating contribution is a registration request for requesting registration of a modified recipe provided by an assignee to whom the recipe was assigned, and
wherein, in the granting, the point is granted to the assignee when the registration request is received.

7. The granting method according to claim 1,
wherein the information indicating contribution is a registration request for requesting registration of a modified recipe provided by an assignee to whom the recipe was assigned, and
wherein, in the granting, the point is granted to the assignee when registration of the recipe indicated in the registration request is permitted.

8. The granting method according to claim 1,
wherein the information indicating contribution is a message for the recipe, and
wherein, in the granting, the point is granted to the sender of the message when the message is received.

9. An information processing device, comprising:
a communication unit that receives, via a network, information indicating contribution to a recipe for a dish; and
a processing unit that grants a point for the recipe after the communication unit receives the information indicating contribution.

10. A program causing a computer to implement:
receiving, via a network, information indicating contribution to a recipe for a dish; and
granting a point for the recipe after receiving the information indicating contribution.
